(19) United States
(12) Patent Application Publication
(10) Pub. No.: US 2026/0148306 A1
(43) Pub. Date: May 28, 2026

(54) METHODS AND SYSTEMS FOR GENERATING A RESOURCE DATASET BASED ON PROCESSING COMMUNICATION DATA

(71) Applicant: SmartHeritance Inc., Campbell, CA (US)

(72) Inventor: Pravat Kumar Lall, San Jose, CA (US)

(21) Appl. No.: 19/395,325

(22) Filed: Nov. 20, 2025

Related U.S. Application Data
(60) Provisional application No. 63/726,294, filed on Nov. 28, 2024.

(51) Int. Cl. G06Q 40/06; H04L 9/32

(52) U.S. Cl. CPC G06Q 40/06; H04L 9/3213

(57) ABSTRACT

Methods and systems for generating a resource dataset on processing communication data are disclosed. The method performed by the system includes accessing an account of a user associated with a communication platform. The method includes identifying communication data related to one or more assets of the user based on a first set of rules. The method includes extracting by one or more Artificial Intelligence (AI) models associated with the system, resource content from the identified communication data based on a second set of rules. Herein, the resource content indicates details related to the one or more assets of the user. The method includes generating a resource list based on the extracted resource content. The method includes generating at least one resource dataset based on the resource list.

### TECHNICAL FIELD

The present invention relates to data processing techniques, and more particularly relates to methods and systems for generating resource datasets for users based on processing communication data (such as digital communication).

### BACKGROUND

Many individuals work diligently to build wealth or assets, but fail to share critical financial details with their beneficiaries. Typically, wealth or asset building refers to the process of accumulating financial resources, investments, and tangible or intangible assets over time to achieve financial security, stability, and long-term prosperity. Further, failing to notify the beneficiaries about the accumulated wealth or assets may lead to several significant problems, including unclaimed assets, financial complications for their beneficiaries, inefficient asset management, legal complications, and so on, after the death or incapacitation of the individual.

Traditional techniques deployed for managing the individual's assets involve structured and time-tested approaches to ensure proper organization, protection, and growth of wealth. The traditional techniques often focus on documentation, professional advice, and legal mechanisms to effectively manage and transfer the assets. One such example involves manual record keeping, i.e., maintaining detailed documentation of the assets such as bank accounts, property deeds, insurance policies, and investment portfolios. Often, the individual may use conventional tools like spreadsheets or physical files to track income, expenses, debts, and ownership details. Also, the assets of the individual are dynamic and may change over the lifetime of the individual, which makes it difficult for the individual to update the asset details accordingly. For example, the individual may open a new online investment account or acquire a new real estate property. In this scenario, if the individual fails to maintain updated asset information, the individual's heirs may face unidentified or unclaimed assets, thereby resulting in financial loss. Further, the individual may utilize other traditional techniques such as banking records, investment portfolio statements, will documentation, and so on, for record keeping. The traditional techniques discussed above involve manual processes that require discipline, effort, and attention to keep records updated. Furthermore, the traditional techniques are inefficient in tracking the assets of the individual as the asset details are often spread across various locations and formats. Moreover, manual documentation or paper records are susceptible to theft, damage, or loss. In addition, traditional techniques are susceptible to accessibility issues, thus causing difficulty for beneficiaries in locating or understanding asset details during emergencies.

Therefore, there is a need for systems and methods to detect asset information to overcome the aforementioned limitations, in addition to providing other technical advantages.

### SUMMARY

Various embodiments of the present disclosure provide methods and systems for generating resource datasets for users based on processing communication data.

In an embodiment, a computer-implemented method for generating resource datasets for users based on processing communication datais disclosed. The computer-implemented method performed by a system includes accessing an account of a user associated with a communication platform. The computer-implemented method further includes identifying communication data related to one or more assets of the user based on a first set of rules. Further, the computer-implemented method includes extracting, by one or more Artificial Intelligence (AI) models associated with the system, resource content from the identified communication data based on a second set of rules. Herein, the resource content indicates details related to the one or more assets of the user. The computer-implemented method further includes generating a resource list based on the extracted resource content. The computer-implemented method further includes generating at least one resource dataset based on the resource list.

In another embodiment, a system is disclosed. The system includes a communication interface and a memory including executable instructions. The system also includes a processor communicably coupled to the memory. The processor is configured to execute the instructions to cause the system, at least in part, to access an account of a user associated with a communication platform. Further, the system is caused to identify communication data related to one or more assets of the user based on a first set of rules. Furthermore, the system is caused to extract by one or more Artificial Intelligence (AI) models associated with the system, resource content from the identified communication data based on a second set of rules. Herein, the resource content indicates details related to the one or more assets of the user. Additionally, the system is caused to generate a resource list based on the extracted resource content. Further, the system is caused to generate at least one resource dataset based on the resource list.

In yet another embodiment, a non-transitory computer-readable storage medium is disclosed. The non-transitory computer-readable storage medium includes computer-executable instructions that, when executed by at least a processor of a system, cause the system to perform a method. The method performed includes accessing an account of a user associated with a communication platform. The method further includes identifying communication data related to one or more assets of the user based on a first set of rules. Further, the method includes extracting, by one or more Artificial Intelligence (AI) models associated with the system, resource content from the identified communication data based on a second set of rules. Herein, the resource content indicates details related to the one or more assets of the user. The method further includes generating a resource list based on the extracted resource content. The method further includes generating at least one resource dataset based on the resource list.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a simplified block diagram of a systemused for generating at least one resource dataset, in accordance with an embodiment of the present disclosure;

FIG. 3 illustrates a flow diagram depicting step-by-step operations for accessing an account of a user associated with a communication platform, in accordance with an embodiment of the present disclosure;

FIG. 4 illustrates an exemplary representation of a user interface (UI) depicting the at least one resource dataset, in accordance with an embodiment of the present disclosure;

FIG. 5 is a simplified block diagram of an authorization server, in accordance with an embodiment of the present disclosure;

FIG. 6 illustrates an exemplary representation of the UI depicting the resource list, in accordance with an embodiment of the present disclosure;

FIG. 7 illustrates an exemplary representation of the UI depicting one or more assets, in accordance with an embodiment of the present disclosure;

FIG. 8 illustrates an exemplary representation of the UI depicting liabilities, in accordance with an embodiment of the present disclosure;

FIG. 9 illustrates an exemplary representation of the UI depicting a dashboard of a resource management application, in accordance with an embodiment of the present disclosure;

FIG. 10 illustrates a process flow diagram depicting a method for generating aresource dataset based on processing communication data, in accordance with an embodiment of the present disclosure; and

FIG. 11 is a simplified block diagram of an electronic devicecapable of implementing various embodiments of the present disclosure.

The drawings referred to in this description are not to be understood as being drawn to scale, except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

### Overview

Various embodiments of the present disclosure provide methods and systems for generating resource datasets for users based on processing communication data (e.g., electronic mail).

In an embodiment, the systemis configured to receive one or more user details from a user. Then, the system is configured to generate a user profile for the user based on the one or more details. Further, the system is configured toaccess an account of a user associated with a communication platform. For accessing the account of the user, the system is configured to transmit an authorization request to an authorization server via a resource management application managed by the system.

Then, the system is configured to receive an authentication response in response to successful authentication of login credentials associated with the account of the user and consent of the user. The system receives the authentication response from the authorization server. Herein, the authentication response includes an authorization code. Further, the system is configured to transmit an authorization code to the authorization server in response to receiving the authorization code. Then, the system is configured to receive an access token from the authorization server based on validating the authorization code. Herein, the access token facilitates the resource management application to access the communication data associated with the account of the user being managed by the communication platform.

The system is further configured to identify communication data related to one or more assets of the user based on a first set of rules. Herein, the first set of rules includes predefined criteria for preprocessing the communication data, including attachments and embedded images. The first set of rules further includes the predefined criteria for identifying the communication data related to the resources of the user. Herein, the communication data includes data related to at least one of banking information, insurance policies, real estate assets, digital assets, social media accounts, and liabilities related to the user.

Then, the system is configured to extract resource content from the identified communication data based on a second set of rules. Herein, the second set of rules includes predefined criteria for identifying resource content from the communication data. For extracting the resource content, the system is configured to utilize one or more Artificial Intelligence (AI) models associated with the system. Further, the system is configured to generate a resource list based on the extracted resource content. Furthermore, the system is configured to generate at least one resource dataset based on the resource list. Moreover, the system is configured to perform a periodic scan of the account of the user. Then, the system is configured to update the at least one resource dataset with new communication data, including the new asset details obtained from the periodic scan.

Moreover, the system is configured to encrypt the at least one resource dataset using one or more encryption techniques. Further, the system is configured to transmit the at least one resource datasetto a corresponding beneficiary of a plurality of beneficiaries based on one or more predefined conditions set by the user. Herein, the beneficiary is selected by the user during a one-time registration process of the user in a resource management application managed by the system. Furthermore, the system is configured to receive inputs related to one or more editing operations for modifying the resource list. Moreover, the system is configured to generate a modified resource list based on implementing the one or more editing operations. Then, the system is configured to generate the at least one resource dataset based on the modified resource list.

Various embodiments of the present disclosure offer multiple advantages and technical effects. For instance, the proposed approach automates the identification and organization of asset-related information from a user's communication data using artificial intelligence (AI) models. This significantly reduces theeffort typically involved in asset documentation and management. The proposed approach enables secure, periodic, and scalable extraction and updating of resource datasets, ensuring that critical financial information remains current and readily accessible. This facilitates the timely dissemination of asset details to designated beneficiaries, potentially preventing asset loss due to unawareness or mismanagement. Additionally, by excluding personal data during extraction and implementing encryption techniques for secure storage, the system ensures compliance with data privacy standards. The ability to support multiple communication platforms further enhances the adaptability and user convenience, making it a robust tool for efficient digital estate planning and resource visibility.

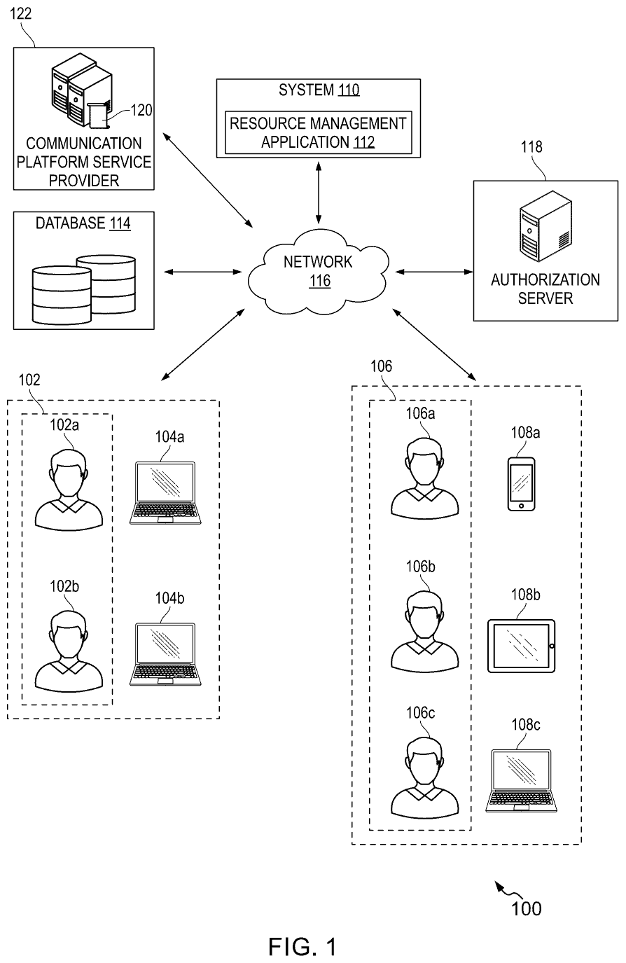

Various embodiments of the present invention are described hereinafter with reference to FIG. 1 to FIG. 11.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 is configured to perform one or more operations, such as generating at least oneresource dataset based on communication data (such as digital communication). As shown, the environment 100 includes a plurality of users 102. The plurality of users 102 may include a user 102a and a user 102b. The plurality of users 102 is depicted to include only two users, however, there can be any number of users. The users 102a and 102b are associated with a user device 104a and a user device 104b, respectively. Further, the environment 100 includes a plurality of beneficiaries 106. The plurality of beneficiaries 106 may include a beneficiary 106a, a beneficiary 106b, and a beneficiary 106c. The plurality of beneficiary 106 is depicted to include only three users, however, there can be any number of users. The beneficiaries 106a-106c include a user device 108a, a user device 108b, and a user device 108c, respectively. The user devices 104a-104b and the user devices 108a-108c may include at least a laptop computer, a phablet computer, a handheld personal computer, a virtual reality (VR) device, a netbook, a Web book, a tablet computing device, a smartphone, or other mobile computing devices. Furthermore, the environment 100 includes a system 110, a database 114, an authorization server 118, and a communication platform service provider 122, connected to each other via a network 116.

Various entities in the environment 100 may connect to the network 116 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 116 may include a secure protocol (e.g., Hypertext Transfer Protocol (HTTP)), and/or any other protocol, or set of protocols. In an example embodiment, the network 116 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

In an embodiment, the users 102a-102b are the users who own resources. Herein, the resources correspond to assets owned by the users 102a-102b. In other words, the assets of the users 102a-102b refer to the resources, items, or holdings that the respective users 102a-102b own, manage, or have rights to access. The assets may be tangible, like physical items (e.g., vehicles, real estate, financial accounts, or valuable possessions), or intangible, such as digital assets(e.g., cryptocurrency, online accounts, intellectual property, or personal data). The assets are typically valuable and may require secure storage, management, or tracking, often through specialized systems that allow users 102a-102b to organize, access, and monitor their assets. Effective asset management is essential for security, maximizing value, and ensuring ease of access when needed.

In one embodiment, the beneficiaries 106a-106c may be the users designatedby the asset owners (such as the users 102a-102b). In other words, the beneficiaries 106a-106c are individuals or entities designated to receive certain rights, benefits, or the assets owned by the users 102a-102b, either during the lifetime of the users 102a-102b or upon the death of the users 102a-102b. For example, the beneficiaries 106a-106c may include family members, business partners, trusts, charities, or other designated parties associated with the users 102a-102b. Further, the entitlement of the beneficiaries 106a-106c may depend on the terms set by the users 102a-102b, which can specify how and when the assets are to be transferred, whether immediately, at a specific age, or under certain conditions. For example, the beneficiaries 106a-106c may receive different types of assets, such as financial assets (cash, stocks, bonds), property (real estate, valuable possessions), or even future benefits (insurance payouts, trust fund distributions).

The environment 100 further includes the system 110. The system 110 may be embodied in at least one computing device in communication with the network 116. The system 110 may be specifically configured, via executable instructions, to perform one or more of the operations described herein. In general, the system 110 is configured to generate the at least one resource dataset based on the communication data, which will be explained further in detail.

The system 110 is configured to host and manage a resource management application 112. Further, one or more components of the resource management application 112 (hereinafter interchangeably referred to as ‘the application 112’) may be stored in the database 114. In an embodiment, the database 114 may be a separate entity in the environment 100 and connected to other entities (e.g., the system 110) of the environment 100 via the network 116. In one embodiment, the database 114 may be embodied in the system 110.

The application 112 is a set of computer-executable codes configured to allow the users 102a-102b to leverage the services of the system 110 to create the at least one resource dataset for the users 102a-102b based on accessing corresponding communication data of the users 102a-102b. In one embodiment, the application 112 may be accessed as a web-based application on the user devices 104a-104b. In another embodiment, the user devices 104a-104b may access an instance of the application 112 from the system 110 for installation on the user devices 104a-104b using application stores associated with operating systems such as Apple iOS®, Android™ OS, Google Chrome OS, Symbian OS®, Windows Mobile® OS, and the like.

The environment 100 further includes the communication platform service provider 122. The communication platform service provider 122 corresponds to a specializedserver that manages the transmission, storage, and retrieval of communication data (e.g., digital communication data), facilitating communication between senders (such as the users 102a-102b) and recipients (e.g., individuals, enterprise, financial institutions, etc.) across different devices and networks. The communication platform service provider 122 may be configured to host and manage a communication platform 120. The communication platform 120 may be equipped in the user devices 104a-104b to enable the users 102a-102b to utilize the services of the communication platform 120 for managing their digital communication data. The communication platform 120 may be a software or web-based application. Some non-limiting examples of the communication platform 120 may include Microsoft® Outlook®, Gmail®, Yahoo™ Mail, icloud™ email, and so on. In one example scenario, the communication platform 120 may provide electronic mail (e-mail) services to the users 102a-102b. E-mail services are one of the most common forms of digital communication which provide an efficient and instantaneous method of communication over the Internet. In other words, E-mail services are integral to digital communication, offering a reliable, fast, and effective method for individuals and businesses to connect and share information.

The user (such asthe user 102a) who wishes to utilize the services of the system 110 for managing his/her resources (e.g., the assets) may be required to register in the application 112. For description purposes, the present disclosure i.e., generating the at least one resource dataset, transmitting the at least one resource dataset to the beneficiaries 106, and so on, is explained with reference to the user 102a. It is apparent that similar operations are implemented for the user 102b to generate the at least one resource dataset, transmit the at least one resource dataset to the beneficiaries, and so on.

The user 102a may be provided with a user interface (not shown in figures) in the application 112 for completing a one-time registration process to access the services of the application 112 or the system 110. For completing the one-time registration process. The system 110 is configured to receive one or more user details (hereinafter referred to as inputs) from the user 102a. The inputs may include, but are not limited to, contact information (e.g., email address), name, mobile phone number, beneficiary details, etc. For example, the user 102a may select the beneficiary 106a to whom the at least one resource dataset of the user 102a will be transmitted in case of emergency events (such as the death of the user 102a) or during the lifetime of the user 102a. Then, the system 110 is configured to generate a user profile for the user 102 based on the inputs as part of the registration process.

Upon successful registration, the application 112 redirects the user 102a to the authorization server 118. The authorization server 118 may be associated with the communication platform service provider 122. In one embodiment, the authorization server 118 may be embodied in the communication platform service provider 122. In some embodiments, the authorization server 118 may be a separate entity of the environment 100, which may be communicably coupled to the communication platform service provider 122 via the network 116.

Further, the user 102a may be required to enter the contact information (e.g., email address) and an authentication code for accessing an account of the user 102a. This account is managed by the communication platform 120 associated with the communication platform service provider 122. Herein, the contact information and the authentication code correspond to login credentials of the account associated with the communication platform 120. The authorization server 118 authenticates the contact information and the authentication code to provide access to the account of the user 102a. In addition, the user 102a may provide input for providing consent to access the account of the user 102a. Further, the authorization server 118 transmits an authorization response to the system 110 based on the successful authentication of the login credentials and the receipt of the input indicating the consent of the user 102a. The authorization response is utilized by the application 112 to access the communication data of the account associated with the user 102a. Herein, the communication data may be the e-mails associated with the user 102a, and the account corresponds to a mailbox managing the e-mails of the user 102a in the communication platform 120.

In addition, the system 110 may be configured to access the communication data of the account for a predetermined time from the time of completing the one-time registration of the user 102a to leverage the services of the system 110. In other words, the system 110 performs a first scan of the communication data in the mailbox that is received for the predetermined time. For example, the predetermined time may be 18 months dating back from the time of receipt of the authorization response or the first scan.

Thereafter, the system 110 is configured to identify the communication data that is related to the resources (or one or more assets) of the user 102a based at least on a first set of rules. Herein, the first set of rules includes predefined criteria for preprocessing the communication data, including attachments and embedded images, and identifying the communication data related to the resources of the user 102a. Herein, the communication data includes data related to at least one of banking information, insurance policies, real estate assets, digital assets, social media accounts, and liabilities related to the user 102a. The first set of rules may be pre-configured in the system 110. In an embodiment, the first set of rules utilizes a compiled domain list for identifying the communication data related to the resources. This compiled domain list can include a set of domains related to financial institutions, crypto accounts, retirement accounts, digital currency accounts, social media accounts, cloud storage accounts, online services, utility accounts, and so on.

The first set of rules allows the system 110 to scrutinize the communication data associated with the account and identify the communication data that is related to the assets of the user 102a. In particular, the system 110 implements one or more artificial intelligence (AI) models to apply the first set of rules for processing the communication data (e.g., e-mails), including attachments and embedded images, to identify the communication data (the e-mails) that are related to the assets of the user 102a. Upon identifying the communication data related to the assets (or the resources) of the user 102a, the communication data isimported to the application 112 for further processing.

The system 110 may implement the one or more artificial intelligence (AI) models to apply a second set of rules to extractresource content from the identified communication data (such as the e-mails) related to the resources of the user 102a. Here, the second set of rules includes predefined criteria for identifying resource content from the communication data. Herein, the identified resource content corresponds to the asset details. The system 110 is further configured to generate a resource list based on the resource content extracted from the communication data. The resource list is further rendered to the user 102a in the application 112 for seeking approval from the user 102a. Upon receipt of the approval, the system 110 generates the at least one resource dataset from the resource list and stores the at least one resource dataset in the database 114. In an embodiment, the system 110 is configured to receive inputs related to one or more editing operations from the user 102a. These editing operations may be related to editing (add, remove, and so on) the resource list to modify asset details in the resource list. Then, the system 110 is configured to generate a modified resource list based on implementing the one or more editing operations. Thereafter, the system 110 generates the at least one resource dataset for the user 102a based on the modified resource list. Additionally, the system 110 is configured to encrypt the at least one resource dataset of the user 102a using one or more encryption techniques, prior to storing the at least one resource dataset in the database 114. For example, the encryption techniques may include the Secure Hash Algorithm (SHA) 256-bit encryption technique.

Further, the system 110 is configured to perform a periodic scan of the mailbox (i.e., the account) of the user 102a to update the at least one resource dataset of the user 102a. Here, the at least one resource dataset of the user 102 may be updated with new communication data, including the new asset details obtained from the periodic scan. It is to be noted that the system 110 is configured to perform the one or more operations as explained above to update the at least one resource dataset. Furthermore, the user 102a may provide access to multiple accounts associated with a same communication platform or different communication platforms managed by corresponding communication service providers (not shown in figures) to access the asset information of the user 102a from the multiple accounts.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

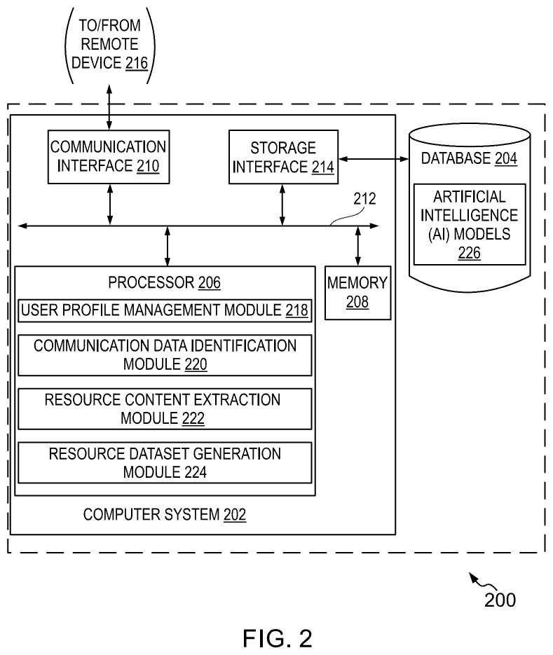

FIG. 2 illustrates a simplified block diagram of a system 200 used for generating the at least one resource dataset, in accordance with an embodiment of the present disclosure. Examples of the system 200 may include, but are not limited to, the system 110 as shown in FIG. 1. The system 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212.

In one embodiment, the database 204 is integrated within the computer system 202 and configured to store an instance of the application 112 and one or more components of the application 112. The one or more components of the application 112 may include, but not limited to, asset data related to the users. The computer system 202 may include one or more hard disk drives as the database 204. The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute computer-readable instructions. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In some embodiments, the memory 208 may be realized in the form of a database server or cloud storage working in conjunction with the system 200, without deviating from the scope of the present disclosure.

The processor 206 is operatively coupled to the communication interface 210 such that the processor 206 is capable of communicating with a remote device 216 such as the user devices 104a-104b, the user devices 108a-108c, the authorization server 118, the communication platform service provider 122, or with any entity connected to the network 116 as shown in FIG. 1.

It is noted that the system 200, as illustrated and hereinafter described, is merely illustrative of an apparatus that could benefit from embodiments of the present disclosure and, therefore, should not be taken to limit the scope of the present disclosure. It is noted that the system 200 may include fewer or more components than those depicted in FIG. 2.

In one embodiment, the processor 206 includes a user profile management module 218, a communication data identification module 220, a resource content extraction module 222, and a resource dataset generation module 224. As such, the one or more components of the processor 206, as described above, are communicably coupled with the application 112.

The user profile management module 218 includes suitable logic and/or interfaces for managing a user profile of the users 102a-102b in the application 112. In other words, the user profile management module 218 is configured to manage user registration of the users (such as the users 102a-102b) to provide access to the services of the application 112. The user 102a may be provided with a user interface (not shown in figures) in the application 112 for completing a one-time registration process to access the services of the application 112 or the system 200. The user 102a may provide inputs in the application 112 for completing the one-time registration process. The inputs may include, but are not limited to, contact information (e.g., email address), name, mobile phone number, beneficiary details, etc. For example, the user 102a may select the beneficiary 106a to whom the at least one resource dataset of the user 102a will be transmitted in case of emergency events (such as the death of the user 102a). Upon receipt of the inputs, the user profile management module 218 creates a user profile for the user 102a in the application 112. Further, creating the user profile establishes individuals (i.e., the user 102a) as registrants of the application 112.

Additionally, access to the services of the application 112 may be provided to the user 102a based on the user 102a selection of a subscription type associated with the application 112. The subscription type may include a trial subscription, a base subscription, a premium subscription, and the like. Further, the processor 206 is configured to request access to the communication data of the user 102a associated with the communication platform 120. The processor 206 is provided with access to the communication data of the account managed by the communication platform service provider 122 based on the authorization response being transmitted by the authorization server 118, as explained with reference to FIG. 1.

The communication data identification module 220 includes suitable logic and/or interfaces for accessing the communication data associated with the account managed by the communication platform service provider 122. More specifically, the communication data identification module 220 may implement one or more artificial intelligence (AI) models 226 for identifying the communication data related to the resources (or the assets) associated with the user 102a from the account (i.e., the mailbox) managed by the communication platform 120.

The AI models 226 may include at least text classification models, Named-Entity Recognition (NER) models, topic modeling, intent detection models, document classification models, and the like. The AI models 226 may be configured to implement the first set of rules for identifying the communication data related to the resources of the user 102a from the account (i.e., the mailbox). The first set of rules may allow the AI models 226 to preprocess the communication data (i.e., the emails) by removing unnecessary information, normalizing text, and segmenting content for analysis. Further, the AI models 226 may be configured to categorize the communication data (i.e., the emails) into asset-related categories (such as invoices, financial statements, or contracts) and non-asset communication data. The AI models 226 may further scan the content of the communication data to identify key details such as asset identifiers, transaction dates, property names, and monetary amounts. Additionally, the AI models 226 may classify the purpose of each asset-related email, such as confirming a transaction, sharing ownership details, or requesting action (e.g., payment).

In one example, the first set of rules may include an asset information list, domain (e.g., www.<xxxxxx>.com, or www.<subdomain>.<xxxxxx>.com) of financial institutions, brokerage lists, mortgage companies lists, retirement account providers, insurance providers, etc. The first set of rules may be stored in the database 204. The communication data identification module 218 implements the AI models 226 to apply the first set of rules to process the communication data including attachments and embedded images, to identify the communication data that are related to the assets (e.g., banking, stock, real estate, mortgage, crypto, escrow, etc.) of the user 102a. Further, the processor 206 may store the identified communication data in the database 204 for further processing.

The resource content extraction module 222 includes suitable logic and/or interfaces for extracting the resource content from the identified communication data. Herein, the identified content corresponds to the asset details. In particular, the resource content extraction module 222 may implement the one or more artificial intelligence (AI) models 226 to apply the second set of rules for identifying the resource content from the identified communication data (such as the emails) related to the assets of the user 102a.

In one example scenario, the resource content extraction module 222, implementing the AI models 226 is configured to identify the resource content from the communication data (e.g., the e-mails) related to financial institutions. For example, the AI models 226 may identify a financial institution's name, website, account type, name on the account, account number associated with the financial institution, and the like. Thereafter, the resource content extraction module 222 extracts the identified resource content related to the financial institution from the communication data.

Further, the step-by-step process of extracting the resource content from the communication data related to the resources of the user 102a is explained below in detail. As explained above, the communication data corresponds to the e-mails of the user 102a. In this scenario, the resource content extraction module 222 may determine the website of the financial institution from the header of the e-mail. Additionally, the resource content extraction module 222 may be configured to perform a reverse lookup of the website against the pre-created list (i.e., the domain of the financial institutions) to determine the ‘name’ and ‘type’ of the financial institution. For example, the AI models 226 are used to identify the resource content from the header of the e-mail. The resource content being identified may include contact information such as ‘accounts@mail.xyz.com’. From this, the resource content extraction module 222 determines the resource content is related to the financial institution, and the name of the financial institution is XYZ bank. Thereafter, the resource content extraction module 222 extracts the website (e.g., www.xyz.com) of the financial institution.

Further, the resource content extraction module 222 is configured to scan the subject field of the e-mail to extract different types of information from pre-populated patterns. For example, the subject may include the statement ‘Your statement about your Checking Account 5348’. In this scenario, the resource content extraction module 222 determines the following details:
a. Asset type to be a ‘Bank Account’
b. Sub-account type is ‘Checkingaccount’
c. Account Number is 5348

In an embodiment, the account number may be masked (e.g., XXXX5438 or . . . 5438). In such scenarios, the resource content extraction module 222 may extract the masked or partial resource content from the e-mail. Thus, during the initial extraction process, the resource content, such as the financial institution name, asset type, and website, is determined from the e-mail related to the financial institution. Further, the resource content extraction module 222 implements the AI models 226 to access the body of the email based on the extracted resource content (such as the financial institution name, asset type, and website). The AImodels 226 determines if the account type is checking, savings, or retirement account type from the body of the email. At this point, the resource content extracted by the processor 206 includes the financial institution's name, website, asset type, account type, and account number. In an embodiment, the AI models 226 may be configured to process the full email (including header, body, and attachment) sequentially to determine the institution type, website, address, and so on. In another embodiment, the AI models 226 may perform one or more operations related to processing the email at a single instance to determine the institution type, website, address, and so on.

In an embodiment, the resource content extraction module 222 may process the emails based on a set of heuristics. The set of heuristics can include sender's email address, subject header, message structure, content of the email, specific keywords present in either in the subject or in the body of the email, patterns used for addressing the user 102a, whether the email is about intimating statuses, activity or prompting any actions from the user 102a and so on.

It is to be noted that the processor 206 is configured to extract minimal resource content from the communication data, excluding the personal data from the communication data. In particular, the system 200 is pre-configured with the first set of rules and the second set of rules to extract the minimal resource content from the communication data (e.g., the e-mails) and exclude the extraction of the personal data of the user 102a. Herein, the minimal resource content from the communication data (such as the e-mail) related to the financial institution may include the financial institution's name, website, asset type, account type, and account number. In one scenario, if the minimal resource content as per the first set of rules and the second set of rules is extracted from the communication data, the processor 206 may be configured to exclude further processing of e-mail attachments. In another scenario, if the minimal resource content is not obtained for the assettype, and if there is an attachment for the e-mail, the resource content extraction module 222 extracts the attachment and implements the AI models 226 for further processing of the attachment of the e-mail. In an embodiment, the attachment may be password-protected. In this scenario, the processor 206 mayrender a user interface (UI) in the application 112 for receiving appropriate passwords from the user 102a to gain access to the e-mail attachments that are password-protected.

In another example scenario, the resource content extraction module 222, implementing the AI models 226, is configured to identify the resource content from the communication data (e.g., the e-mails) related to stock accounts (or investments). For example, the AI models 226 may identify a brokerage name (or a trading company's name), website, account type, name on the account, account number associated with the financial institution, and the like. Thereafter, the resource content extraction module 222 extracts the identified resource content related to the stock accounts from the communication data.

In another example scenario, the resource content extraction module 222, implementing the AI models 226, is configured to identify the resource content from the communication data (e.g., the e-mails) related to mortgages. For example, the AI models 226 may identify a mortgage provider's name, website, real estate property address, loan number, loan amount, and the like. Thereafter, the resource content extraction module 222 extracts the identified resource content related to the real estate asset and associated mortgages from the communication data.

In another example scenario, the resource content extraction module 222, implementing the AI models 226, is configured to identify the resource content from the communication data (e.g., the e-mails) related to the insurance details. For example, the AI models 226 may identify a provider name, website, insured's name, policy number, and the like. Thereafter, the resource content extraction module 222 extracts the identified resource content related to the insurance details from the communication data.

In another example scenario, the resource content extraction module 222, implementing the AI models 226, is configured to identify the resource content from the communication data (e.g., the e-mails) related to the retirement accounts. For example, the AI models 226 may identify aninstitution'sname, account type, account number, and the like. Thereafter, the resource content extraction module 222 extracts the identified resource content related to the retirement accounts from the communication data.

The resource dataset generation module 224 includes suitable logic and/or interfaces for generating the at least one resource dataset of the user 102a. In particular, the resource dataset generation module 224 generates the resource list upon extracting the resource content from the communication data related to the resources (or the assets) of the user 102a. The resource list corresponds to a preliminary list that includes the resource content being extracted from the communication data.

The processor 206 transmits the resource list to the user 102a for seeking approval from the user 102a. The resource list may be rendered in the application 112 as explained above. In an embodiment, the resource list may be transmitted to the e-mail address of the user 102a from which the communication data related to the resources of the user 102a is retrieved. The user 102a may provide inputs in the application 112 to perform one or more operations, such as verifying the entries in the resource list, editing the resource list, and the like.

In one scenario, the user 102a provides approval of the resource list. In this scenario, the application 112 may transmit a verification response to the system 200 indicating the approval of the resource list. Thereafter, the resource dataset generation module 224 generates the at least one resource dataset based on the resource list. In another scenario, an entry in the resource list may include the bank account details of the user 102a associated with the financial institution (e.g., ‘ABC bank’). The bank account details may include only the financial institution's name and the account type. In this scenario, the user 102a may provide inputs in a corresponding field of the application 112 to add the account number of the bank account of the user 102a associated with the financial institution. Upon providing the inputs to add the account number, the user 102a may approve the resource list. Thereafter, the resource dataset generation module 222 updates the resource list with the bank account number based on the inputs provided by the user 102a and generates the at least one resource dataset for the user 102a. In another scenario, the bank account number of the user 102a associated with the financial institution listed in the resource list may include a partial or masked account number (e.g., XXXX5678). In this scenario, the user 102a may provide inputs to provide the full account number associated with the financial institution. Upon providing the inputs related to the full account number, the user 102a may approve the resource list for generating the at least one resource dataset.

Additionally, the processor 206 may be configured to encrypt the at least one resource dataset of the user 102a using one or more encryption techniques, prior to storing the at least one resource dataset in the database 204. For example, the encryption techniques may include the Secure Hash Algorithm (SHA) 256-bit encryption technique. Further, the processor 206 may discard the communication data retrieved from the account (i.e., the mailbox) after processing the communication data (or the generation of the at least one resource dataset or updation of the at least one resource dataset). In an embodiment, the user 102a may provide inputs to discard the communication data upon processing.

In an embodiment, the user 102a may provide inputs related to the beneficiary for each resource content of the resource list. For example, the resource list includes an entry related to resources such as the insurance of the user 102a. The user 102a may provide the inputs to add the beneficiary (e.g., the beneficiary 106a) for the insurance of the user 102a.

Further, the processor 206 is configured to perform a periodic scan of the mailbox (i.e., the account) of the user 102a to update the at least one resource dataset of the user 102a. Herein, updating the resource dataset corresponds to updating the asset details of the at least one resource dataset and/or updating the at least one resource dataset with new asset details obtained from the periodic scan. In an embodiment, the period scan of the account of the user 102a is performed based on the subscription type of the user 102a with the application 112. The subscription type may include the trial subscription, the base subscription, the premium subscription, and the like. For example, the frequency of the periodic scan of the trial subscription, the base subscription, and the premium subscription is 0, once in 6 months, and every 3 months, respectively. Thus, the processor 206 is configured to store the timestamp of each scan of the account for performing the periodic scans based on the subscription type opted by the user 102a.

Further, the processor 206 is configured to transmit the at least one resource dataset to a corresponding beneficiary 106a of the plurality of beneficiaries 106 based on one or more predefined conditions set by the user 102a. Here, the beneficiary 106a is selected by the user 102a during the one-time registration process of the user 102a in the application 112 managed by the system 110. In an example, the one or more predefined conditions can outline various ways in which the plurality of beneficiaries 106 may use the social media accounts or cloud storage of the user 102a. The various ways can include downloading, editing, or deleting the contents of the cloud storage, posting further contents in the social media account, memorializing the social media accounts, deleting the social media accounts, and so on. The one ormore predefined conditions can also include specific instructions to the plurality of beneficiaries 106 from the user 102a.

In an embodiment, once the system (e.g., the system 110 or the system 200) identifies and extracts the at least one resource dataset, including the one or more assets and/or liabilities associated with the user 102a, the user 102a is prompted, via the resource management application 112, to review and validate the identified entries. The review process may include confirming, editing, or deleting asset and/or liability records displayed within the application 112. Upon confirmation by the user 102a, the system 110 stores the validated entries within a dedicated data repository (such as the database 204) associated with the user 102a.

The database 204 is further configured to aggregate the validated entries with any pre-existing asset and/or liability information of the user 102a maintained within the system 200, thereby generating a comprehensive and unified resource dataset for the user 102a. Each record within the resource dataset is stored along with metadata such as a validation timestamp, a source identifier (e.g., communication platform or manually added entry), and a user confirmation flag, ensuring traceability and data integrity across all records.

In one embodiment, the resource dataset may be subjected to one or more encryption and access control mechanisms to ensure confidentiality and secure storage of user data. The encryption mechanisms may include the Secure Hash Algorithm (SHA)-based encryption or other industry-standard cryptographic techniques. The access control mechanisms may enforce user-specific privileges and system-level restrictions to prevent unauthorized modification or retrieval of the stored data.

Further, the system 200 manages dissemination of the stored asset and/or liability information to the plurality of beneficiaries 106 identified by the user 102a during a registration or configuration process in the application 112. The dissemination or access to the resource dataset is governed by the one or more predefined conditions set by the user 102a. In an embodiment, the one or more predefined conditions include, but are not limited to detection of the death of the user 102a or a similar terminal event verified through a death verification protocol implemented by the system 200, or explicit consent or configuration provided by the user 102a, enabling view-only access to the plurality of beneficiaries 106 while the user 102a remains alive.

In the first scenario, upon confirmation of the user's death, the system 200 automatically grants access to or transmits the relevant portion of the at least one resource dataset to the corresponding beneficiaries 106 based on the user's predefined configuration. The transmission may occur through secure data channels or encrypted document sharing within the application 112.

In the second scenario, the user 102a grants view-only access to the at least one resource dataset while alive. In this scenario, the system 200 enables the plurality of beneficiaries 106 to access the selected asset and/or liability details through a restricted interface rendered in the application 112. Herein, the access permissions are limited to viewing the data without allowing any modification, deletion, or transfer of the stored records. The scope of viewable data may be further controlled by the user 102a by specifying asset categories, institution names, or account identifiers visible to each of the plurality of beneficiaries 106.

Additionally, the system 110 maintains an audit log of all access events, including timestamps, user identifiers, and action types, to ensure full transparency and traceability of data access by beneficiaries. The audit information may be viewable by the user 102a within the dashboard of the application 112.

Through the foregoing mechanism, the system 110 ensures that validated financial and liability information of the user 102a is securely preserved in a legacy format and made accessible to the designated beneficiaries 106 only under authorized and verifiable conditions. This ensures compliance with the user's intent, enhances data confidentiality, and provides a structured framework for the delegated management of the user's digital and financial estate.

It is to be noted that the processor 206 is configured to perform the one or more operations as explained above to update the at least one resource dataset. Additionally, the processor 206 may be configured to identify one or more duplicate entries in the resource list generated upon extracting the resource content from the communication data retrieved from the subsequent scan (e.g., after 6 months) of the account (i.e., the mailbox) of the user 102a associated with the communication platform 120. Herein, the duplicate entries are those for which the information/the resource content already exists in the at least one resource dataset of the user 102a.

For example, if a bank account ending in ‘xxxx2437’ already is part of the at least one resource dataset, then identifying the same bank account from the communication data, including a recent bank statement, will not result in a new entry. In this scenario, the processor 206 is configured to facilitate the removal of the identified duplicate entries from the generated resource listthat is being transmitted to the user 102a after the subsequent scan. Further, the processor 206 may be configured to identify new resources (or the assets) from the communication data retrieved from the subsequent scan. For example, if there is a new stock brokerage account (maybe even from the same brokerage, but a new account), the processor 206 identifies the ‘brokerage account’ as a new asset and includes it in the resource list to be transmitted to the user 102a for seeking approval. Thereafter, the processor 206 updates the at least one resource dataset of the user 102a with the resource list of the subsequent scan upon the receipt of the verification response from the application 112 in response to the user inputs related to the approval of the resource list generated from the subsequent scan.

Furthermore, the user 102a may provide access to multiple accounts associated with the same communication platform or different communication platforms managed by corresponding communication servers (not shown in figures) to access the asset information of the user 102a from the multiple accounts. For example, the user 102a may provide access to an account (such as ‘a mailbox A’) associated with ‘communication platform A’. In this scenario, the processor 206 generates the at least one resource dataset based on processing the communication data retrieved from the mailbox A. Upon completion of the processing of the communication data retrieved from the mailbox A, the user 102a may provide access to another account (such as ‘a mailbox B’) associated with ‘communication platform B’. In this scenario, the processor 206 updates the at least one resource dataset of the user 102a based on processing the communication data retrieved from the mailbox B.

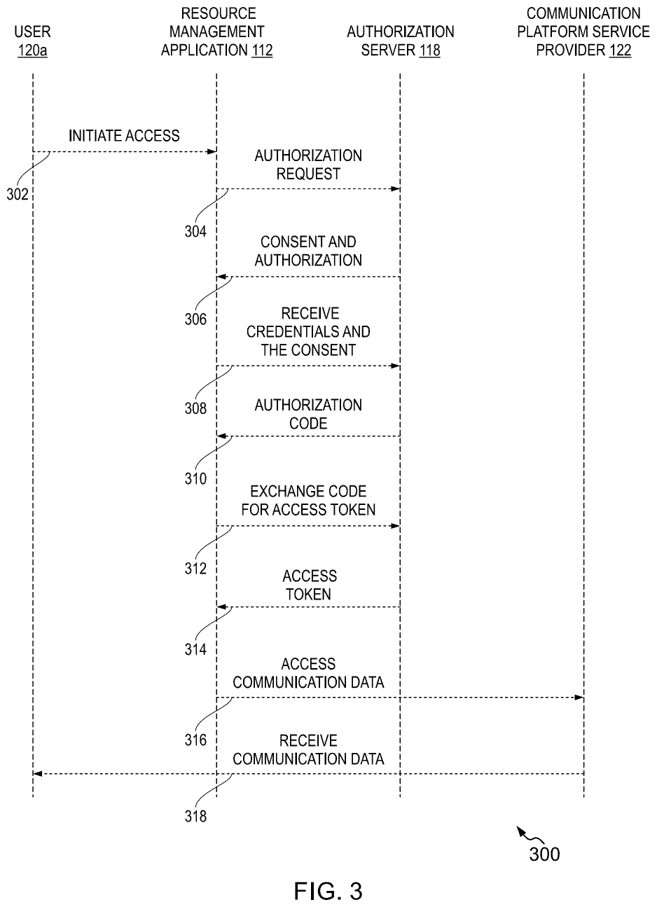

FIG. 3 illustrates a flow diagram 300 depicting step-by-step operations for accessing the account of the user 102a associated with the communication platform 120, in accordance with an embodiment of the present disclosure. Operations of the flow diagram 300, and combinations of operations in the flow diagram 300, may be implemented by, for example, hardware, firmware, a processor, circuitry, and/or a different device associated with the execution of software that includes one or more computer program instructions.

At 302, the user 102a initiates the authorization process by requesting the application 112 to access the account (e.g., the mailbox) of the user 102a associated with the communication platform 120. As explained above, the account facilitates the user 102a to manage the communication data (i.e., the digital communication) associated with the user 102a. The communication data includes e-mails.

At 304, the application 112 transmits an authorization request to the authorization server 118. Herein, the authorization request is transmitted to the authorization server 118 via the application 112 managed by the system 110. In particular, the user 102a is redirected to the authorization server 118 to provide access to the mailbox of the user 102a, which is managed by the communication platform 120.

At 306, the authorization server 118 prompts the user 102a to log into the account and displays the consent screen with the requested permissions. In particular, the authorization server 118 determines whether the user 102a has logged in to the account associated with the communication platform 120. If the user 102a has not logged in to the account, the authorization server 118 prompts the user 102a to provide the login credentials for the account (see, 308 of FIG. 3). Thereafter, the authorization server 118 authenticates the login credentials to allow the user 102a to loginto the account associated with the communication platform 120. Additionally, the user 102a provides inputs related to the consent for allowing the application 112 to access the communication data associated with the account (see, 308 of FIG. 3).

At 310, the authorization server 118 redirects the user 102a to the application 112 with an authorization code upon receipt of the user 102a consent to the requested permissions and authentication of the login credentials. Herein, the authentication code corresponds to the authentication response. More specifically, the application 112 is configured to receive the authentication response from the authorization server 118 in response to successful authentication of login credentials associated with the account of the user 102a and consent of the user 102a.

At 312, the application 112 exchanges the authorization code with the authorization server 118 for an access token by making a secure request to the authorization server 118.

At 314, the authorization server 118 issues the access token to the application 112 based on validating the authorization code. Herein, the access token facilitates the resource management application to access the communication data associated with the account of the user 102a being managed by the communication platform.

At 316, the application 112 uses the access token to make application programming interface (API) calls to the communication platform service provider 122 to access the communication data associated with the account of the user 102a.

At 318, the communication platform service provider 122 validates the access token and returns the requested communication data to the application 112. As explained above, the application 112 is configured to access the communication data for the predetermined time (e.g., 18 months) or at the time of periodic scans (e.g., 6 months or 3 months). In particular, forthe periodic scans, the access token for the communication platform 120 received from the application 112 may haveexpired. In this scenario, the authorization server 118 may prompt the user 102a to log into the account and provide permission to access the account. Thereafter, the authorization server 118 issues the access token for the periodic scans. Similarly, the access token for the periodic scans may be used until the access token expires. The one or more operations related to accessing the communication data are already explained with references to FIGS. 1 and 2, therefore, they are not reiterated herein for the sake of brevity.

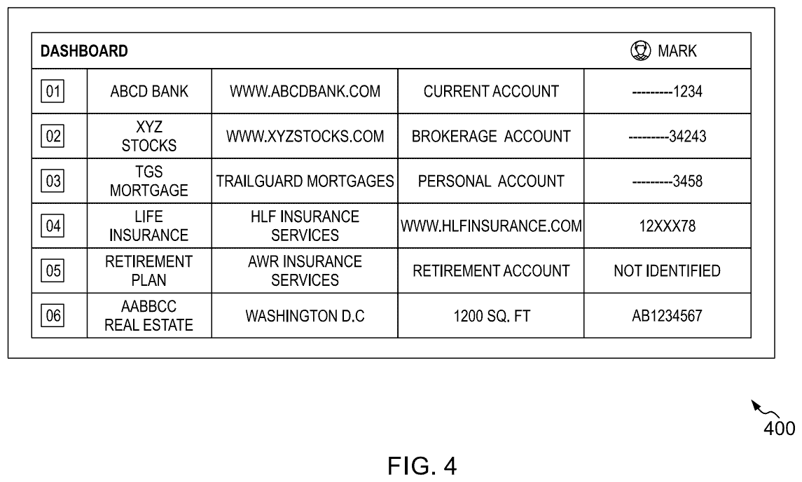

FIG. 4 illustrates an exemplary representation of a user interface (UI) 400 depicting the at least one resource dataset, in accordance with an embodiment of the present disclosure. As shown, the UI 400 is depicted to include different types of resources (or the assets) associated with the user 102a. The at least one resource dataset depicted in the UI 400 exemplarily includes the details of the banking, financial institutions, insurance, real estate assets, associated mortgages, and retirement accounts.

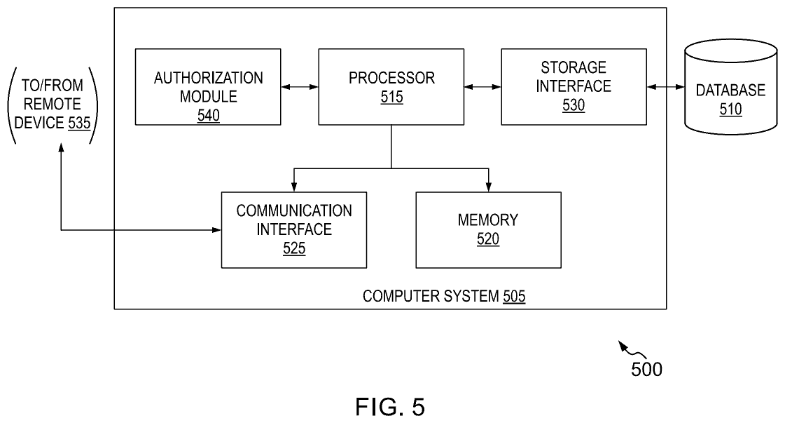

FIG. 5 is a simplified block diagram of an authorization server 500, in accordance with one embodiment of the present disclosure. The authorization server 500 is an example of the authorization server 118 of FIG. 1. The authorization server 500 may be a separate part and may operate apart via the network 116 (as shown in FIG. 1). The authorization server 500 performs one or more operations as explained above. The authorization server 500 includes a computer system 505 and a database 510.

The computer system 505 includes at least one processor 515 for executing instructions. Instructions may be stored in, for example, but not limited to, a memory 520. The processor 515 may include one or more processing units (e.g., in a multi-core configuration). The processor 515 is operatively coupled to a communication interface 525 such that the computer system 505 is capable of communicating with a remote device 535 such as the user devices 104a-104b, the system 110/200, the communication platform service provider 122, or any other entity of FIG. 1. For example, the communication interface 525 may facilitate communication between the authorization server 500 and the remote device 535.

The processor 515 may also be operatively coupled to the database 510. In some embodiments, the database 510 is integrated within the computer system 505. For example, the database 510 may include multiple storage units such as hard disks and/or solid-state disks in a redundant array of inexpensive disks (RAID) configuration. The database 510 may include a storage area network (SAN) and/or a network attached storage (NAS) system. In some embodiments, the database 510 is integrated within the computer system 505. For example, the computer system 505 may include one or more hard disk drives as the database 510. In other embodiments, the database 510 is external to the computer system 505 and may be accessed by the computer system 505 using a storage interface 530. The storage interface 530 is any component capable of providing the processor 515 with access to the database 510. The storage interface 530 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 515 with access to the database 510.

The processor 515 of the authorization server 500 is configured to detect if the user 102a has logged into the account associated with the communication platform 120. Further, the processor 515 prompts the user 102a to log into the account and displays the consent screen with the requested permissions if the user 102a has not logged in to the account. The authorization server 500 further includes an authorization module 540. The authorization module 540 is configured to receive the login credentials of the account and authenticate the login credentials to allow the user 102a to log into the account associated with the communication platform 120. Furthermore, the authorization module 540 transmits the authorization code upon receipt of the user's 102a consent to the requested permissions and authentication of the login credentials. Thereafter, the processor 515 of the authorization server 500 provides the access token to the user 102a in response to the authorization code. The one or more operations performed by the authorization server 500 are already explained with references to FIGS. 1 to 4, and therefore they are not reiterated herein for the sake of brevity.

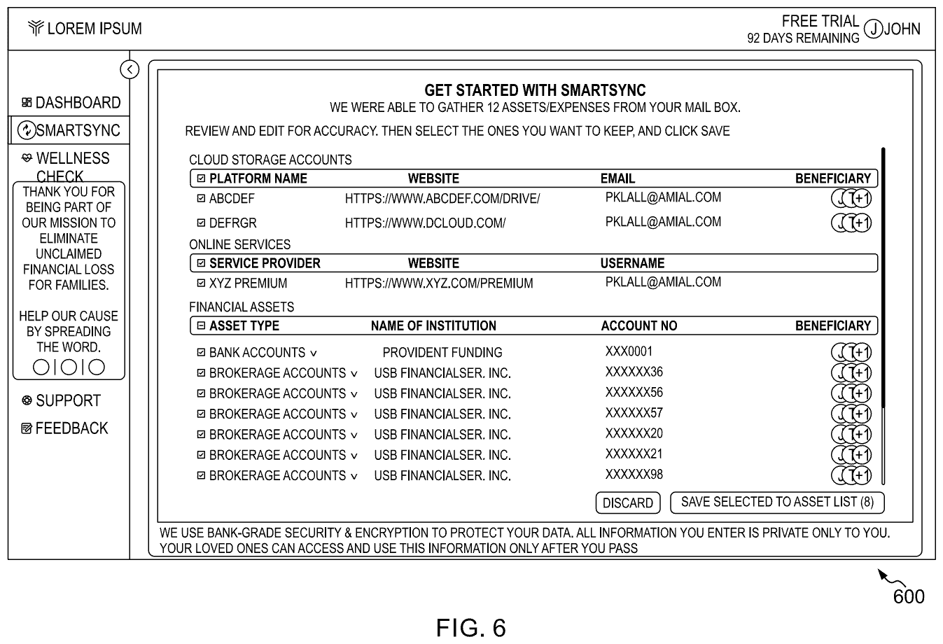

FIG. 6 illustrates an exemplary representation of the UI 600 depicting the resource list, in accordance with an embodiment of the present disclosure. It can be seen that, the resource list includes details of various cloud storage accounts associated with the user 102a, various online services availed by the user 102a, and various financial assets owned by the user 102a. Further, the resource list includes details of beneficiaries related to each of these assets or liabilities as applicable. In addition to that, in association with the financial assets, the resource list provides detailed information regarding the name of the institutions and the corresponding account numbers as well. The resource list also provides information related to webpages associated with online services and cloud storage accounts, along with the respective email addresses.

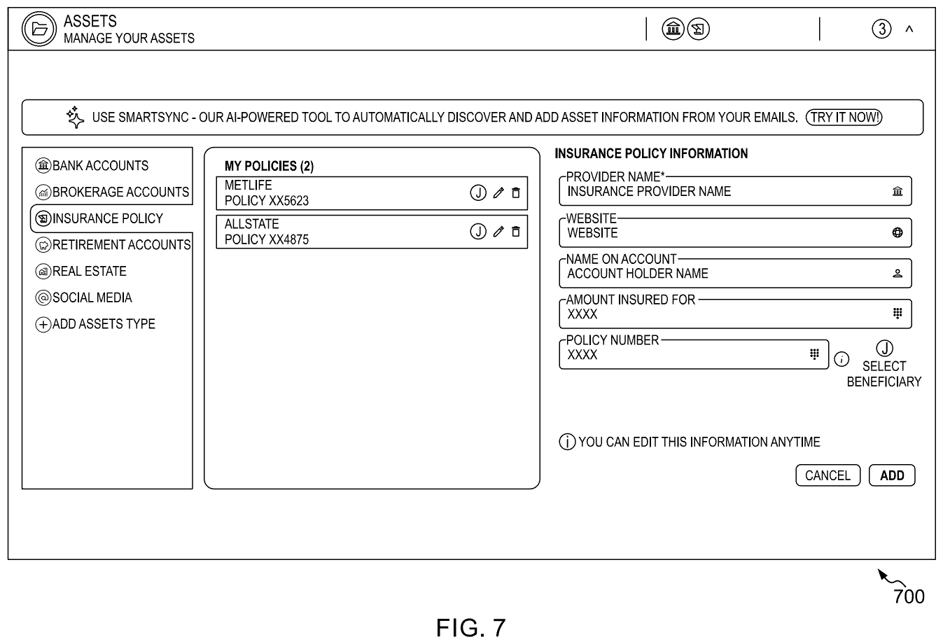

FIG. 7 illustrates an exemplary representation of the user UI 700 depicting the assets, in accordance with an embodiment of the present disclosure. It can be seen that the UI 700 provides information regarding various asset types such as bank accounts, brokerage accounts, insurance policies, retirement accounts, real estate, social media accounts, and the like. The UI 700 also provides an option to the user 102a for selecting at least one beneficiary for each of these asset types.

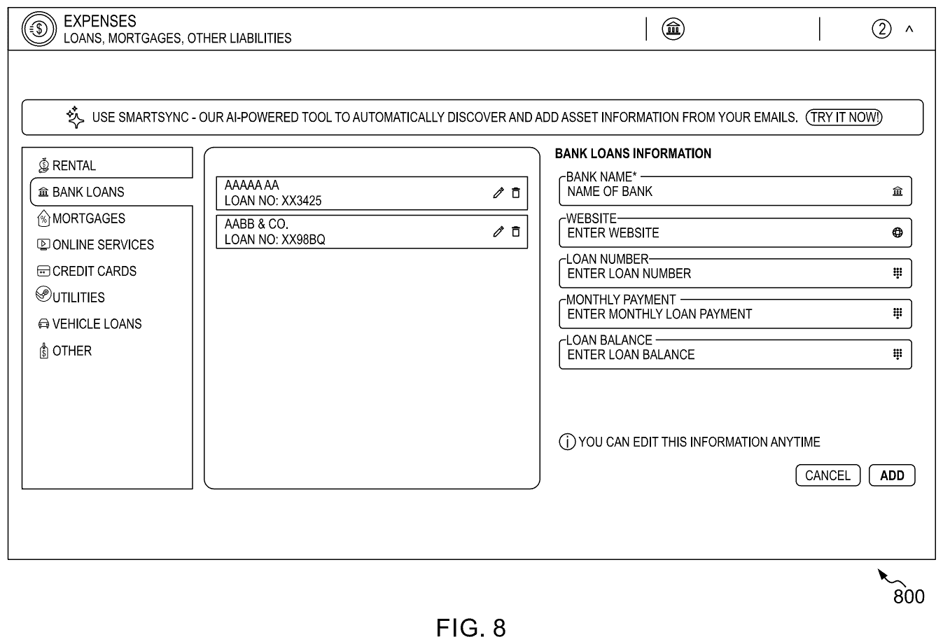

FIG. 8 illustrates an exemplary representation of the UI 800 depicting liabilities, in accordance with an embodiment of the present disclosure. It can be seen that the UI 800 renders details of various liabilities associated with the user 102a. These liabilities can include rentals, bank loans, mortgages, online services, credit cards, utilities, vehicle loans, and so on.

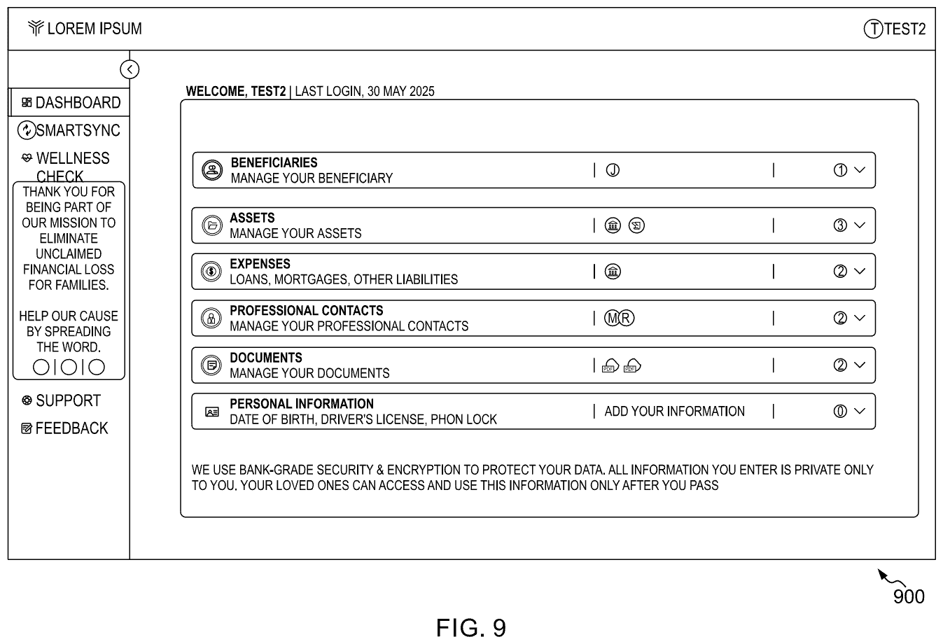

FIG. 9 illustrates an exemplary representation of the UI 900 depicting a dashboard of the application 112, in accordance with an embodiment of the present disclosure. It can be seen that the dashboard of the application 112 provides a quick glance at the plurality of beneficiaries 106, assets, expenses, professional contacts, documents, personal information, and so on. The personal information can include details of date of birth, driver's licence, phone lock password of the user 102a, and so on.

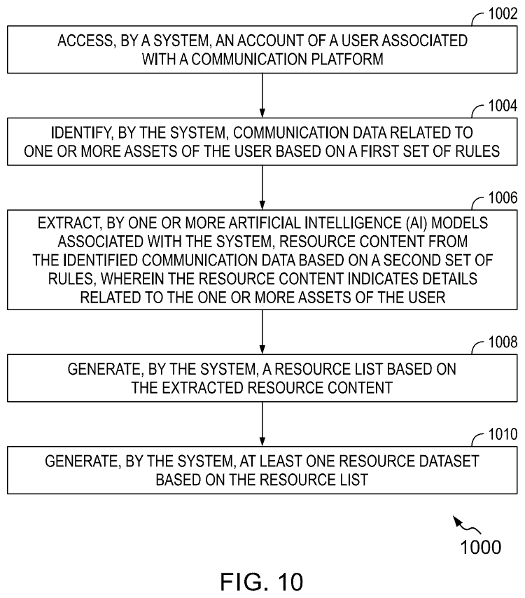

FIG. 10 illustrates a process flow diagram depicting a method 1000 for generating a resource dataset based on processing communication data, in accordance with an embodiment of the present disclosure. The method 1000 depicted in the flow diagram may be executed by, for example, the system 200. The sequence of operations of the method 1000 may not necessarily be executed in the same order as they are presented. Further, one or more operations may be grouped and performed in the form of a single step, or one operation may have several sub-steps that may be performed in parallel or in a sequential manner. Operations of the method 1000, and combinations of operations in the method 1000 may be implemented by, for example, hardware, firmware, a processor, circuitry, and/or a different device associated with the execution of software that includes one or more computer program instructions. The plurality of operations is depicted in the process flow of the method 1000. The process flow starts at operation 1002.

At operation 1002, the method 1000 includes accessing, by a system such as the system 200, an account of a user 102a associated with a communication platform 120.

At operation 1004, the method 1000 includes identifying, by the system 200, communication data related to one or more assets of the user 102a based on a first set of rules.

At operation 1006, the method 1000 includes extracting, by one or more Artificial Intelligence (AI) models 226 associated with the system 200, resource content from the identified communication data based on a second set of rules. Herein, the resource content indicates details related to the one or more assets of the user 102a.

At operation 1008, the method 1000 includes generating, by the system 200, a resource list based on the extracted resource content.

At operation 1010, the method 1000 includes generating, by the system 200, at least one resource dataset based on the resource list.

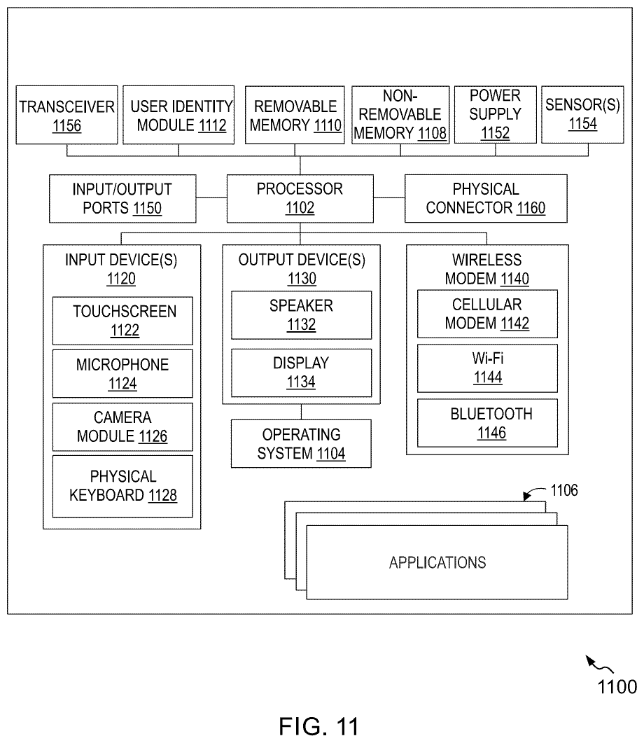

FIG. 11 is a simplified block diagram of an electronic device 1100 capable of implementing various embodiments of the present disclosure. For example, the electronic device 1100 may correspond to the user devices 104a-104b and the user devices 108a-108c of FIG. 1. The electronic device 1100 is depicted to include one or more applications 1106. For example, the one or more applications 1106 may include the application 112 of FIG. 1. The one or more applications 1106 installed on the electronic device 1100 are capable of communicating with a system (i.e., the system 200 or the system 110) to manage the inheritance of resources.

It should be understood that the electronic device 1100, as illustrated and hereinafter described, is merely illustrative of one type of device and should not be taken to limit the scope of the embodiments. As such, it should be appreciated that at least some of the components described below in connection with the electronic device 1100 may be optional and thus in an embodiment may include more, less, or different components than those described in connection with the embodiment of the FIG. 11. As such, among other examples, the electronic device 1100 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1100 includes a controller or a processor 1102 (e.g., a signal processor, microprocessor, ASIC, or other control and processing logic circuitry) for performing such tasks as signal coding, data processing, image processing, input/output processing, power control, and/or other functions. An operating system 1104 controls the allocation and usage of the components of the electronic device 1100 and supports one or more operations of the application (see, the applications 1106) that implements one or more of the innovative features described herein. In addition, the applications 1106 may include common mobile computing applications (e.g., telephony applications, email applications, calendars, contact managers, web browsers, messaging applications) or any other computing application.

The illustrated electronic device 1100 includes one or more memory components, for example, a non-removable memory 1108 and/or a removable memory 1110. The non-removable memory 1108 and/or the removable memory 1110 may be collectively known as a database in an embodiment. The non-removable memory 1108 can include RAM, ROM, flash memory, a hard disk, or other well-known memory storage technologies. The removable memory 1110 can include flash memory, smart cards, or a Subscriber Identity Module (SIM). The one or more memory components can be used for storing data and/or code for running the operating system 1104 and the applications 1106. The electronic device 1100 may further include a user identity module (UIM) 1112. The UIM 1112 may be a memory device having a processor built in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in the form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1100 can support one or more input devices 1120 and one or more output devices 1130. Examples of the input devices 1120 may include, but are not limited to, a touch screen/a display screen 1122 (e.g., capable of capturing finger tap inputs, finger gesture inputs, multi-finger tap inputs, multi-finger gesture inputs, or keystroke inputs from a virtual keyboard or keypad), a microphone 1124 (e.g., capable of capturing voice input), a camera module 1126 (e.g., capable of capturing still picture images and/or video images) and a physical keyboard 1128. In an embodiment, the output devices 1130 may include, but are not limited to, a speaker 1132 and a display 1134. Other possible output devices can include piezoelectric or other haptic output devices. Some devices can serve more than one input/output function. For example, the touch screen 1122 and the display 1134 can be combined into a single input/output device.

A wireless modem 1140 can be coupled to one or more antennas (not shown in FIG. 11) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device, or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the electronic device 1100 and a public switched telephone network (PSTN).

The electronic device 1100 can further include one or more input/output ports 1150, a power supply 1152, one or more sensors 1154 for example, an accelerometer, a gyroscope, a compass, or an infrared proximity sensor for detecting the orientation or motion of the electronic device 1100 and biometric sensors for scanning biometric identity of an authorized user, a transceiver 1156 (for wirelessly transmitting analog or digital signals) and/or a physical connector 1160, which can be a USB port, IEEE 1294 (FireWire) port, and/or RS-232 port. The illustrated components are not required or all-inclusive, as any of the components shown can be deleted, and other components can be added.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a system, an account of a user associated with a communication platform;
identifying, by the system, communication data related to one or more assets of the user based on a first set of rules;
extracting, by one or more Artificial Intelligence (AI) models associated with the system, resource content from the identified communication data based on a second set of rules, wherein the resource content indicates details related to the one or more assets of the user;
generating, by the system, a resource list based on the extracted resource content; and
generating, by the system, at least one resource dataset based on the resource list.

2. The computer-implemented method as claimed in claim 1, wherein accessing the account of the user comprises:
transmitting, by the system, an authorization request to an authorization server via a resource management application managed by the system;
receiving, by the system, an authentication response from the authorization server in response to successful authentication of login credentials associated with the account of the user and consent of the user, wherein the authentication response comprises an authorization code;
in response to receiving the authorization code, transmitting, by the system, the authorization code to the authorization server; and
receiving, by the system, an access token from the authorization server based on validating the authorization code, wherein the access token facilitates the resource management application to access the communication data associated with the account of the user being managed by the communication platform.

3. The computer-implemented method as claimed in claim 1, wherein the first set of rules comprises predefined criteria for preprocessing the communication data comprising attachments and embedded images and identifying the communication data related to the resources of the user, wherein the communication data comprising data related to at least one of banking information, insurance policies, real estate assets, digital assets, social media accounts, and liabilities related to the user.

4. The computer-implemented method as claimed in claim 1, further comprising:
encrypting, by the system, the at least one resource dataset using one or more encryption techniques.

5. The computer-implemented method, as claimed in claim 1, further comprising:
performing, by thesystem, a periodic scan of the account of the user; and
updating, by the system, the at least one resource dataset with new communication data comprising the new asset details obtained from the periodic scan.

6. The computer-implemented method, as claimed in claim 1, wherein the second set of rules comprises predefined criteria for identifying resource content from the communication data.

7. The computer-implemented method, as claimed in claim 1, further comprising:
identifying, by the system, one or more duplicate entries in the generated resource list; and
facilitating, by the system, removal of the identified duplicate entries from the generated resource list.

8. The computer-implemented method as claimed in claim 1, further comprising:
transmitting, by the system, the at least one resource datasetto a corresponding beneficiary of a plurality of beneficiaries based on one or more predefined conditions set by the user, wherein the beneficiary is selected by the user during a one-time registration process of the user in a resource management application managed by the system.

9. The computer-implemented method as claimed in claim 1, further comprising:
receiving, by the system, inputs related to one or more editing operations for modifying the resource list;
generating, by the system, a modified resource list based on implementing the one or more editing operations; and
generating, by the system, the at least one resource dataset based on the modified resource list.

10. The computer-implemented method, as claimed in claim 1, further comprising:
receiving, by the system, one or more user details from the user; and
generating, by the system, a user profile for the user based on the one or more details.

11. A system, comprising:
a communication interface;
a memory comprising executable instructions; and
a processor communicably coupled to the communication interface and the memory, the processor configured to cause the system to at least:
accessan account of a user associated with a communication platform;
identifycommunication data related to one or more assets of the user based on a first set of rules;
extract by one or more Artificial Intelligence (AI) models associated with the system, resource content from the identified communication data based on a second set of rules, wherein the resource content indicates details related to the one or more assets of the user;
generate a resource list based on the extracted resource content; and
generate at least one resource dataset based on the resource list.

12. The system as claimed in claim 11, wherein to access the account of the usersystem is further caused, at least in part, to:
transmitan authorization request to an authorization server via a resource management application managed by the system;
receive an authentication response from the authorization server in response to successful authentication of login credentials associated with the account of the user and consent of the user, wherein the authentication response comprises an authorization code;
in response to receiving the authorization code, transmit the authorization code to the authorization server; and
receive an access token from the authorization server based on validating the authorization code, wherein the access token facilitates the resource management application to access the communication data associated with the account of the user being managed by the communication platform.

13. The system as claimed in claim 11, wherein the first set of rules comprises predefined criteria for preprocessing the communication data comprising attachments and embedded images and identifying the communication data related to the resources of the user, wherein the communication data comprising data related to at least one of banking information, insurance policies, real estate assets, digital assets, social media accounts, and liabilities related to the user.

14. The system as claimed in claim 11, wherein the system is further caused, at least in part, to:
encryptthe at least one resource dataset using one or more encryption techniques.

15. The system as claimed in claim 11, wherein the system is further caused, at least in part, to:
performa periodic scan of the account of the user; and
update the at least one resource dataset with new communication data comprising the new asset details obtained from the periodic scan.

16. The system as claimed in claim 11, wherein the second set of rules comprises predefined criteria for identifying resource content from the communication data.

17. The system as claimed in claim 11, wherein the system is further caused, at least in part, to:
identifyone or more duplicate entries in the generated resource list; and
facilitate removal of the identified duplicate entries from the generated resource list.

18. The system as claimed in claim 11, wherein the system is further caused, at least in part, to:
transmit the at least one resource datasetto a corresponding beneficiary of a plurality of beneficiaries based on one or more predefined conditions set by the user, wherein the beneficiary is selected by the user during a one-time registration process of the user in a resource management application managed by the system.

19. The system as claimed in claim 11, wherein the system is further caused, at least in part, to:
receive inputs related to one or more editing operations for modifying the resource list;
generate a modified resource list based on implementing the one or more editing operations; and
generate the at least one resource dataset based on the modified resource list.

20. A non-transitory computer-readable storage medium comprising computer-executable instructions that, when executed by at least a processor of a system, cause the system to perform a method comprising:
accessing an account of a user associated with a communication platform;
identifyingcommunication data related to one or more assets of the user based on a first set of rules;
extracting, by one or more Artificial Intelligence (AI) models associated with the system, resource content from the identified communication data based on a second set of rules, wherein the resource content indicates details related to the one or more assets of the user;
generating a resource list based on the extracted resource content; and
generating at least one resource dataset based on the resource list.
